(19) United States
(12) Patent Application Publication
(10) Pub. No.: US 2002/0103013 A1
(43) Pub. Date: Aug. 1, 2002

(54) Signal detection using a phased array antenna

(76) Inventors: Stephen J. Watson, Malvern (GB); Michael Dean, Malvern (GB); Neil Wallace, Malvern (GB); Andrew M. Smith, Malvern (GB)

Correspondence Address: NIXON & VANDERHYE P.C., 8th Floor, 1100 North Glebe Road, Arlington, VA, 22201, US

(21) Appl. No.: 09/824,564

(22) Filed: Apr. 3, 2001

(30) Foreign Application Priority Data
Jan. 31, 2001 (GB) 0102384.5

(51) Int. Cl. H04M 1/00

(52) U.S. Cl. 455/562; 455/272

(57) ABSTRACT

A method and apparatus for receiving an incident signal using a phased array antenna (1). Embodiments are provided that demonstrate the acquisition, tracking and reception of frequency modulated video signals (63) transmitted by a mobile television radio-camera in a multipath environment.

### BACKGROUND OF THE INVENTION

This invention relates to a method and apparatus for receiving radio frequency (RF) signals to provide an RF link using a phased array antenna.

A typical wireless RF system uses a transmit antenna (transmitter) and a receive antenna (receiver) to support an RF link. In many environments, such as indoors or in enclosed outdoor spaces such as sports stadia, the transmitted signal will be reflected and may therefore reach the receiver via a multitude of different paths, each of different path length. These so called multipath effects can seriously degrade the quality of the received signal.

It is well established in the field of radio communications to use a directional receive antenna to reduce multipath effects. However, when a directional receive antenna is employed it must be constantly, and accurately, directed towards the transmitter.

An example of the use of a directional receive antenna is found in televising events. Radio cameras, whose image signals are transmitted by radio, are used in Outside Broadcasts (OBs) to provide close in pictures of the event being televised. Currently most handheld radio cameras require a directional receiver that is rotated so that it is constantly aligned with the transmitter. This requirement is generally satisfied by using a standard dish antenna and a person (called a panner) who watches where the radio camera goes and rotates the directional receive antenna accordingly. The tracking must be precise and proves difficult if visibility is poor. In addition, if there is no direct line of sight between the receiver and the transmitter, the RF link is generally lost. Ensuring the receive antenna is pointed correctly becomes further complicated when the transmitter is moving.

Recently, digital radio camera systems have been developed in an attempt to overcome the problems associated with multi-path effects. Coded modulation techniques have been demonstrated that actually use the reflected signals to improve the performance of the RF link. However, because of strict health and safety requirements limiting transmit power levels along with compromises in other system parameters, a directional antenna may still be needed if only to satisfy the link budgets. A more complete description of these digital systems can be found in ‘OFDM For Wireless Multimedia Communications’ by Richard Van Nee and Ramjee Prasad, Artech House, 2000.

The use of phased arrays, which are electronically controllable directional transmitter or receiver antenna, is well known in the art of radar technology. Traditional phased array antenna tend to comprise hundreds of elements, each with individual phase shifters working at the operating frequency of the antenna (often 1 GHz and above). A description of such systems is given in N. Fourikis, ‘Phased Array Based Systems And Applications’, Wiley Interscience Publication, 1997, ISBN 0 471 01212 2.

W097/03367 describes a phased array device that can be produced at a much lower cost, and is much smaller in size, than the traditional phased array systems. Instead of phase shifting the signals received at each antenna element at the operating frequency, the RF signals are down converted to a first and then to a second intermediate frequency. During the second down conversion, the phase of the second intermediate frequency signal is changed by controlling the phase of the corresponding local oscillator. As the phase shifting is performed at a much lower frequency than the RF signal, inexpensive devices are available that can provide a high level of phase control. This allows phase shifting to be performed with greater accuracy thereby enabling the number of elements in a phased array antenna to be reduced. These antennas are thus considerably cheaper to produce than the traditional phased array systems. Herein such devices are termed Low Cost (LC) phased array antenna.

To change the directional receive properties of a phased array antenna requires reconfiguration of the phased array by altering the phase and amplitude shifts applied to the signals received by each of the antenna elements. During any such period of phased array antenna reconfiguration there is a risk that the information being received by the phased array antenna will be corrupted.

### SUMMARY OF THE INVENTION

It is an object of this invention to use a phased array antenna, in particular an LC phased array antenna, to acquire and track signals from a transmitter.

According to the first aspect of this invention, a method of reading information from a signal transmitted by a transmitter comprises the steps of taking a phased array antenna, and adjusting said phased array antenna to receive said information.

Advantageously, the method includes the step of determining the direction of incidence on said phased array antenna of said signal and adjusting said phased array antenna to receive said signal accordingly.

The use of a phased array antenna according to the present invention permits reflected signals to be readily and quickly detected allowing the most suitable incident signal to be located and received. This has significant advantages over the prior art where a “panner” would have to manually aim the receiver dish in certain directions to ascertain if a reflected signal could be received.

In a preferred embodiment, the method includes the step of determining the direction of incidence on said phased array antenna of any signals transmitted by said transmitter, and adjusting said phased array antenna to receive the strongest incident signal.

Conveniently, the method includes the step of determining the direction of incidence on said phased array antenna of any signals transmitted by said transmitter, and adjusting said phased array antenna to receive the incident signal of the highest quality.

Advantageously, the method includes the step of adjusting said phased array antenna to receive said signal from said transmitter, tracking any change in the direction of incidence of said signal and adjusting said phased array antenna to receive said signal from the new direction accordingly.

Conveniently, if said signal comprises an information carrying period and a non-information carrying period, said step of tracking any change in the direction of incidence of said signal and adjusting said phased array antenna to receive said signal from the new direction accordingly can be performed substantially during said non-information carrying period of said signal.

The present invention can be seen to have a significant advantage over the prior art “panner” methods because a person is not required to continually track movement of the transmitter; the present invention thus allows completely automated transmitter tracking.

The present invention also has a significant advantage over the prior art “panner” methods when the line of sight between the transmitter and receiver is lost, for example if the transmitter were to pass behind a solid object or an object was to move in-between the transmitter and antenna. In this case, any reflected signal reaching the phased array antenna may still be located and tracked allowing a continuous link with the transmitter to be maintained. Previously, the “panner” would generally lose the capability to track the signal and hence there would be a break in the RF link

In a preferred embodiment, said step of taking a phased array antenna comprises the step of taking an LC phased array antenna.

The use of an LC phased array receiver proves particularly advantageous because, as described above, such devices can be produced at a much lower cost than the traditional devices and are much smaller in size because they use fewer antenna elements.

Advantageously, said signal transmitted by said transmitter comprises a frequency modulated video signal and said phased array antenna receives said frequency modulated video signal. Conveniently, said frequency modulated video signal has a frequency in the range of 12.2 GHz to 12.5 GHz which is the industry standard frequency range for radio-camera operation.

According to a second aspect of this invention, a method of reading information from at least two transmitters, each said transmitter transmitting a signal, comprises the step of taking a phased array antenna and adjusting said phased array antenna to concurrently receive a signal transmitted by each said transmitter.

The present invention thus allows information to be received from more than one transmitter using a single phased array antenna. This is a significant advantage over the prior art “panner” type methods which require a panner and directional receiver for each transmitter.

According to a third aspect of this invention, a method of reading information from at least two signals transmitted by a transmitter comprises the steps of taking a phased array antenna, and adjusting said phased array antenna to concurrently receive said two or more signals.

The present invention thus allows two or more signals, transmitted by a single transmitter, that reach the phased array antenna via a plurality of different routes (for example multi-path reflected signals) to be concurrently received by the phased array antenna.

According to a fourth aspect of this invention, a receiver for receiving an incident signal comprises;

a phased array antenna, said phased array antenna comprising an antenna array, said antenna array comprising a plurality of spatially separated antenna elements, each said antenna element producing an associated electrical signal in response to said incident signal,

a phase shifter, said phase shifter applying a phase shift to each said associated electrical signal to produce a corresponding phase shifted electrical signal,

a phased array controller, said phased array controller controlling the phase shift applied by said phase shifters to said electrical signals,

a combiner, said combiner combining said phase shifted electrical signals thereby producing an electrical output signal,

wherein said phased array controller causes said phase shifters to apply phase shifts such that said electrical output signal contains the information contained in said incident signal.

Advantageously, the receiver may further comprise a signal strength monitor, said signal strength monitor measuring the strength of said electrical output signal. The receiver may also comprise a signal quality monitor, said signal quality monitor measuring the quality of said electrical output signal.

In a preferred embodiment, said incident signal is a frequency modulated analogue video signal.

Conveniently, the receiver may further comprise one or more additional phase shifters, wherein each said additional phase shifter is provided with said electrical signals, said phased array controller controlling the phase shifts applied by said additional phase shifter, and whereby two or more electrical output signals are produced.

According to the present invention, the additional phase shifters allow two or more signals to be concurrently received.

Preferably, the receiver may further comprise one or more signal strength monitors, said signal strength monitors measuring the strength of one or more said electrical output signals. Advantageously, the receiver may further comprise one or more signal quality monitors, said signal quality monitors measuring the quality of one or more said electrical output signals.

### BRIEF DISCUSSION OF THE DRAWINGS

The invention will now be described, by way of example only, with reference to the accompanying figures wherein;

FIG. 1 shows the principle of operation of a phased array receiver;

FIG. 2 illustrates the architecture of an LC phased array receiver for tracking an RF signal;

FIG. 3 shows a schematic illustration of a typical analogue FM signal;

FIGS. 4a and 4b illustrate the reception of signals; and

FIGS. 5a-5c illustrate the use of a dual beam phased array receiver.

### DETAILED DISCUSSION OF PREFERRED EMBODIMENTS

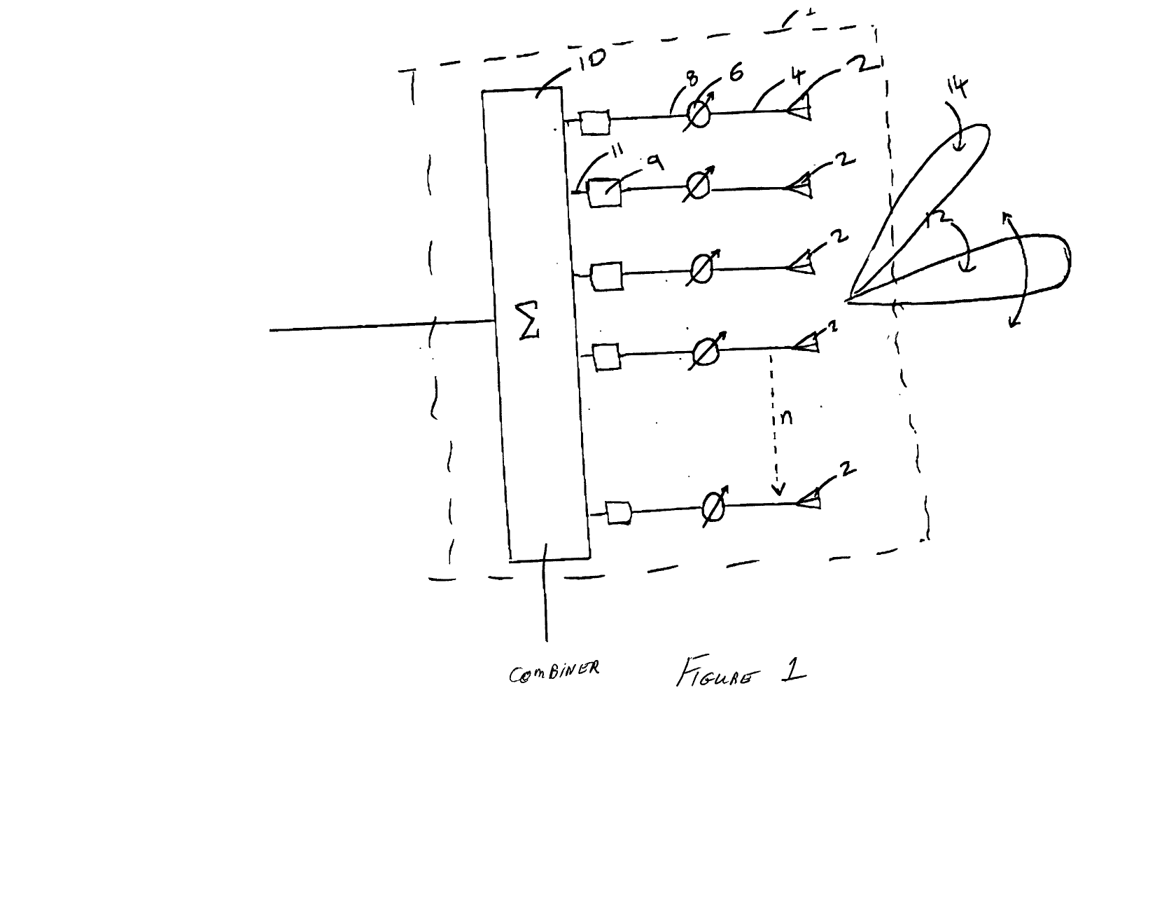

The operation of a general phased array antenna will now be described with reference to FIG. 1.

A phased array antenna receiver (1) comprises n antenna elements (2) which provide electrical signals (4) derived from an incident RF signal (not shown). Phase shifters (6) provide a phase shift to the electrical signals (4) producing phase shifted electrical signals (8). The phase shifted electrical signals (8) are then attenuated by an attenuation means (9) producing signals that are both phased shifted and attenuated (11). The signals that are both phased shifted and attenuated (11) are then combined by a combiner (10).

It is possible to make the phased array antenna receiver particularly sensitive to radiation incident from a certain direction. This is done by controlling both the phase shift applied to each of electrical signals (4), and the relative amplitude weighting given to each of the phased shifted electrical signals (8) by the attenuator (9). As described later in detail, there are several techniques of applying phase shifts to the electrical signals (4).

Selecting phase shifts and amplitude weightings that cause the phased array antenna receiver (1) to have directionally dependent RF signal reception properties is termed beam forming or beam steering. For example, FIG. 1 shows a beam (12) that could be formed by applying certain phase shifts and amplitude weightings to the electrical signals (4) that are produced by the n antenna elements (2). Alternatively, different phase shifts and amplitude weightings could be applied to produce another beam (14). The change in direction is termed beam steering.

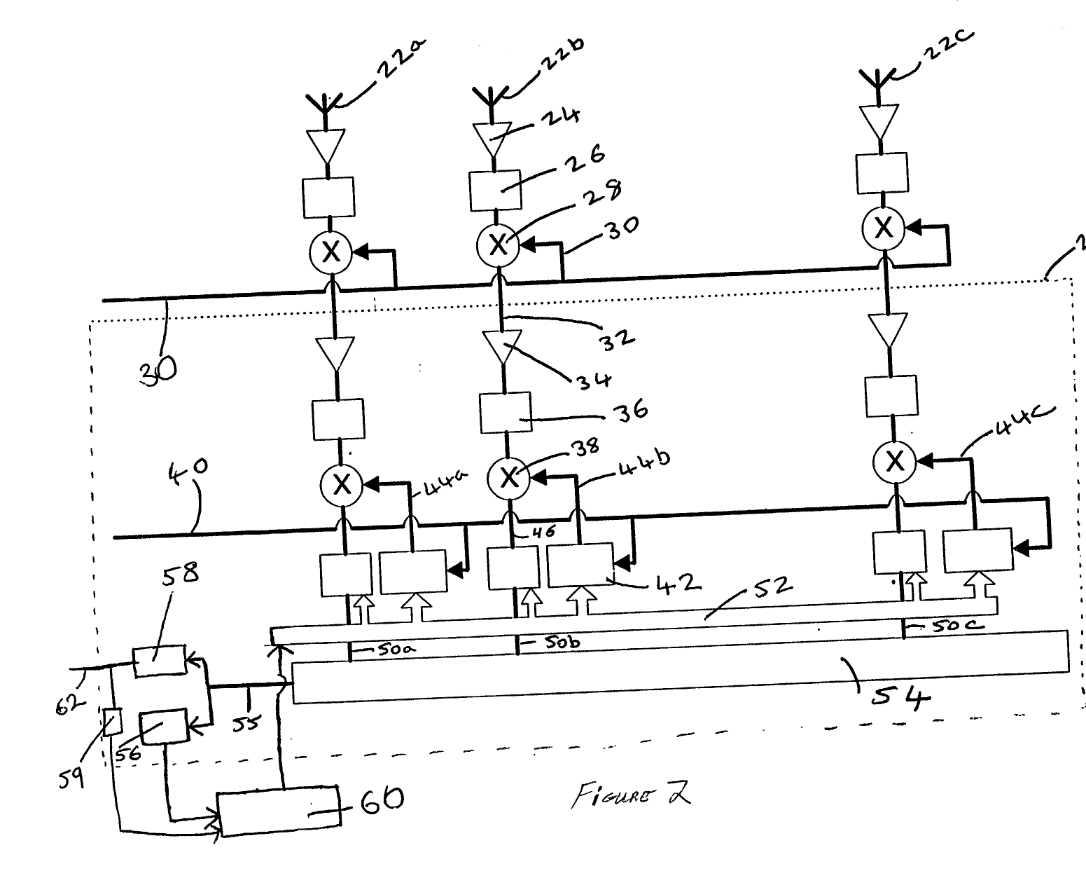

A receive beam, also simply termed a beam, is the angular range over which the detector is sensitive to incident signals. In other words, a receive beam can be considered as a three dimensional area in space and the phased array antenna will be sensitive to any signal incident on it from that three dimensional area. In reality, it is unlikely that perfect beams would be formed; each receive beam would have associated “sidelobes”. Methods of beamforming and the existence and suppression of sidelobes (as described for LC systems with reference to FIG. 2) are well known to persons skilled in the art of phased array radar.

The principle of operation of an LC phased array antenna will now be described with reference to FIG. 2.

The traditional design philosophy for phased array radar systems has been that each element uses an individual phase shifter for phase control. The phase shifter is typically a Monolithic Microwave Integrated Circuit (MMIC) and is characterized by a high cost due to limited production runs and the fact that the device has to function at the operating frequency of the antenna (often 1 GHz and above). The phase shifter is controlled by a digital input. Standard devices are 4 bit giving 22.5° of phase resolution, whilst more complex options have 6 bits that provide approximately 6° of phase resolution. As a result of this relatively low level of phase control, in order for the antenna to be able to scan the beam in 1° or sub-degree steps, hundreds or thousands of elements are required. Hence traditional phased arrays have used hundreds or thousands of expensive MMIC phase shifters and consequently have been utilized almost exclusively by the military for large installations.

It is possible to avoid using individual phase shifters for phase control without the need to employ expensive digital beamforming solutions using the beamforming architecture disclosed in W097/03367.

An LC phased array receiver comprises a plurality of antenna elements (22a, b, c). The electrical signal produced by each antenna element when receiving an RF signal is amplified by low noise amplifiers (24), passes through image reject filters (26) before being down-converted to a first intermediate frequency signal (32) by means of microwave mixers (28). A microwave local oscillator signal (30) is used by the microwave mixers (28) in the down conversion process. The first intermediate frequency signals (32) are then fed into the beamforming hardware (21).

On entering the beamforming hardware (21) the first intermediate frequency signals (32) passes through amplifiers (34), and image reject filters (36), before being down-converted to second intermediate frequency signals (46) by intermediate frequency mixers (38). During this second down-conversion process, phase shifts are introduced by changing the phase of the second local oscillator (LO) signals (44a, b, c) using phase shifter (42) and are then applied to each of the intermediate frequency mixers (38). The phase shift introduced by the phase shifter (42) is controlled by a digital control bus (52), and produces second intermediate frequency phase shifted electrical signals (50a, b, c).

Because the phase shifter (42) used to phase shift the second LO signal operates at a frequency much lower than the RF signal, inexpensive vector modulator devices can be used. A person skilled in the art would be aware of the various types of vector modulator device that would be suitable for this purpose. Typical vector modulator devices, such as those used in mobile phones, are controlled by low cost 12 bit digital-to-analogue converters and provide a very high level (sub 1°) of phase control.

The second intermediate frequency phase shifted electrical signals (50a, b, c) are combined in the combiner (54). A suitable frequency for the second IF electrical signal is 70 MHz. After being combined, the resultant signal (55) is split two ways. One part is cabled into a power detect module (56) whilst the other passes through an Automatic Gain Control (AGC) module (58). After the AGC module, the signal is again split two ways. One part is routed as the output of the antenna (62), whilst the other passes through a suitable demodulator or decoder module (59).

The output of the power detect module (56) can be used by the microcontroller (60) to determine the best position to point the receive beam. The microcontroller (60) also controls, over the digital bus (52), the phase shift that is applied to each second local oscillator signal (44a, b, c) by the phase shifter (42). The AGC module (58) works to keep the output signal (62) at a constant power level of +5 dBm without compromising the linearity of the receive chain. The power detect module (56) and the AGC module (58) work independently of the signal's modulation, and as a result the phased array antenna can acquire and track analogue or digital signals.

The decoder module (59) demodulates or decodes part of the output signal (62) into baseband components. In the case of FM video, the various components of the video can then be measured and may be used to assess the quality of the video signal that is being received. It is thus possible for the microcontroller (60) to use a video signal quality measurement from the decoder module (59) instead of, or as well as, the signal strength measurements provided by the power detect module (56) when deciding how to direct the receive beams.

A synchronization signal is provided by the decoder module (59) to the microcontroller (60) to indicate when the received signal contains no information. The microcontroller (60) only reconfigures the phased array antenna during these periods; hereinafter termed the non-information carrying period.

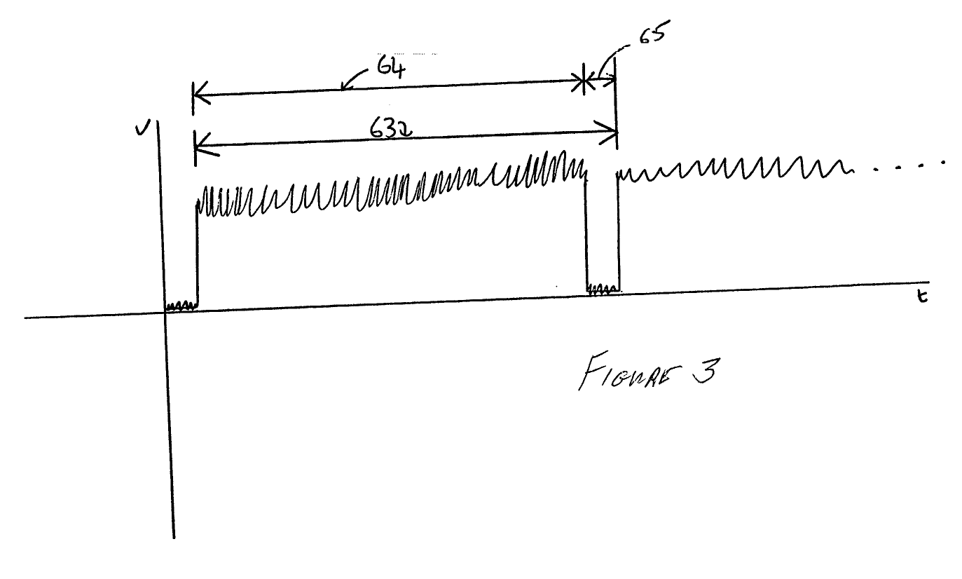

An example of a signal having a non-information carrying period will now be described with reference to FIG. 3.

A FM analogue video signal of a given period (63), typically 20 ms, comprises an information carrying period (64) of typically 18.5 ms and a non-information carrying period (65) of approximately 1.5 ms. The non-information carrying period (65) is commonly termed the “fly-back” portion of the signal. All the video information is contained in the information carrying period (64), and there will be no perceivable interference to the displayed video image if reconfiguration of the phased array antenna is performed during the non-information carrying period (65).

This technique can be applied to any signal, analogue or digital, having a non-information carrying period. For example, a digital signal could be transmitted that contains information for a certain period but is configured to have a non-information carrying period. A person skilled in the art could produce appropriate data buffering systems to ensure continuity of the digital output of data.

The output signal (62) can be routed from the phased array to an Antenna Control Unit (not shown) via a standard tri-axial cable. This cable can also be used to support the control and telemetry data between the phased array and the Antenna Control Unit (ACU) and provide a power supply for the array. The ACU can be located at a convenient position, which may be remote to the phased array antenna itself.

In this embodiment the ACU's function is to provide a suitable interface which the operator can use to control the phased array. However, a person skilled in the art would recognize that many different methods of routing the received signal and control data could be employed (e.g. fiber optic, low frequency radio data links). In addition, the ACU can be fitted with a decoder or demodulator as specified by the user. These options do not affect the fundamental principles underlying this invention and are merely workshop variations which would be immediately apparent to a person skilled in the art.

In order to obtain a discrete set of beams from an LC phased array, the phased array antenna is calibrated before use. A discrete set of beams (for example +50° to −50° in 1° steps) can be calibrated for a given operating frequency or for groups of frequencies within a given band. For each beam there is a phase and amplitude weighting for each element of the antenna. The calibration data is stored, and subsequently used to allow the formation of a given directional beam for a given frequency. During calibration the absolute phase between each of the calibrated beams can be controlled so that it is the same value for each beam. This helps to minimize phase interference whilst switching beams.

In addition to performing a calibration at each operating frequency it is also possible to perform several different calibration types. One set implements zero amplitude attenuation on each element. This provides maximum gain in the main beam, but the sidelobe levels are not controlled. Conversely, a fully weighted calibration set provides maximum sidelobe suppression which results in a reduction in the receiver's susceptibility to multipath effects. The disadvantage of a fully weighted calibration is that the algorithms used to synthesize such beams tend to reduce the gain of the antenna. In addition to the two calibration types described here, there are a multiplicity of calibration options that can be used for a variety of beam patterns. Such calibration types are well known to those skilled in the art of phased array radar technology.

A result of the high level of phase control provided by the LC system described above is that beams can be synthesized and scanned in sub-degree steps from arrays of very few elements (for example 8 or 16 elements). It is also possible to have modular RF front end and beamforming circuits. A typical module consists of 8 radiating elements complete with superheterodyne receiver and phase control circuit. The modules can also be grouped together so as to create a linear or planar phased array antenna that satisfies the system requirements.

For example, two 8 element modules have been combined to produce a 16 element linear phased array antenna. More modules could be combined, for example if a more directional antenna were required. A larger array would have more gain that could support an RF link from a given transmitter over a longer distance. The 16 element array will support an RF link with a conventional handheld radio camera over distances of up to 1 km.

The acquisition arc (i.e. lateral angular range over which beams can be formed) for a 16 element phased array is approximately 100°. Scanning beyond ±50° is possible but at the expense of some degradation in the beam pattern such as increased sidelobe levels and a broadening of the main beam. Supporting an RF link over larger angles is achievable in several ways. A combination of receivers can be located so as the transmitter is always within the acquisition arc of the network, with handovers between arrays occurring automatically at the various boundaries. Alternatively a single receiver can be mounted onto a turntable and the servo driven by control signals generated by the array. A third option is to use a curved RF front end instead of a linear row. Curved surface and full circular arrays have been developed that provide 360° of coverage.

A further advantage of LC phased array devices over traditional phased arrays is that they work independently of the operating frequency of the antenna. Because the beamforming is performed at a low intermediate frequency, the RF frequency of the antenna is unrestricted. Whatever the operating frequency, the RF signal is downconverted to the necessary IF and the phase control implemented using the second IF mixer. This type of detector is thus totally ‘modular’ in frequency; it can be used to receive RF signal of any frequency.

For FM video link applications, frequencies within the 2 GHz or 12 GHz radio camera bands are generally used. For example, 12 25 MHz channels could be provided between 12.2125 GHz and 12.4875 GHz. An LC phased array device can thus be built which can track a radio camera transmitting at an allocated 12 GHz frequency channel with an output of 70 MHz, ±5 dBm (the industry standard).

It is also possible to include additional sets of beamforming hardware in phased array devices. Simultaneous formation of a plurality of receive beams is well known to a person skilled in the art of phased array radar. To simultaneously form multiple receive beams using an LC device, the first intermediate frequency signals (32) are divided and supplied to a plurality of sets of beamforming hardware (21). Each set of beamforming hardware produces output signals from its power detect, AGC, and decoder modules. A single microcontroller can then be used to direct the receive beams associated with each set of beamforming hardware.

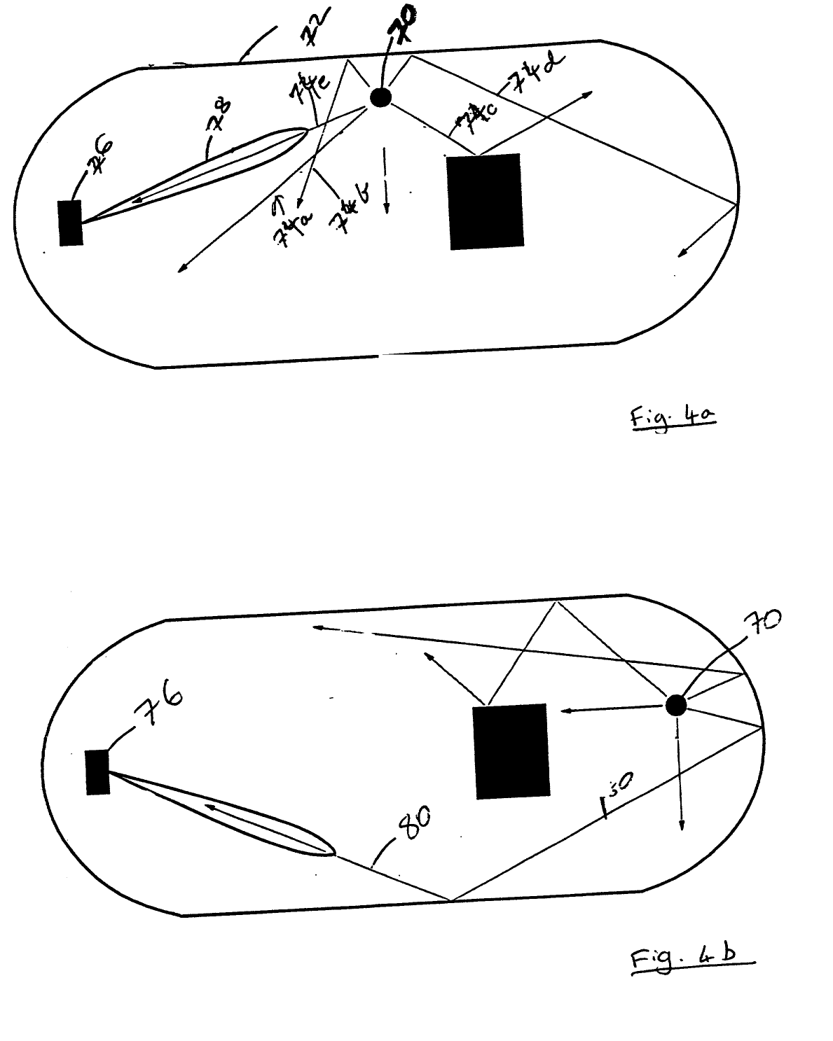

The use of a phased array receiver to acquire and track a transmitted RF signal will now be described, with reference to FIGS. 4a-4b. Although the LC phased array receiver described with reference to FIG. 2 is particularly suitable for implementing the transmitter tracking methods described below, a person skilled in the art would recognize that any phased array receiver could be employed.

When a signal is transmitted by an omni-directional transmitter (70) in an enclosed environment, such as a sports stadium (72), a plurality of multipath RF signals (74a, 74b, 74c, 74d, 74e) are produced. If an omni-directional receiver were used to receive the transmitted signal the many multi-path signals, all of which are slightly out of phase due to travelling along paths of different length, would all be received producing a resultant received signal that has a high level of multi-path interference.

As shown in FIG. 4a and as described above, a phased array receiver (76) can be used to form a directional receive beam (78) which reduces susceptibility to multi-path interference effects. FIG. 4b shows the use of a phased array receiver (76) to receive a reflected signal (80) from an omni-directional transmitter (70) in the absence of any direct line of sight path.

The phased array receiver system must initially ascertain the angle of incidence of a suitable RF signal. This is generally performed by determining the direction from which the strongest transmitted signal originates. Alternatively, the angle of incidence that provides a signal of acceptable strength with the lowest level of multi-path interference (i.e. provides the highest quality signal) could be selected. The strongest, or highest quality, signal may be the line of sight signal, but it may also be a reflection. The process of determining the angle of incidence of a suitable RF signal is herein termed an acquisition scan.

For a full acquisition scan, a typical LC phased array of the type described with reference to FIG. 2 can sequentially load a full set of beams from the selected calibration set (e.g. from +50° to −50° in 1° steps). For each beam loaded, the power of the received signal is measured and the beam that gave the highest reading is selected as the center beam for a ‘mini-scan’. A mini-scan is the same as a full scan but over a much narrower range, and possibly of a higher angular resolution.

The operator can control the angular range over which the initial scan takes place and the number of degrees between each step (1°, 2° etc.), or alternatively can chose to load a single fixed beam. Using a typical LC phased array of the type described with reference to FIG. 2, acquisition of a signal over a 100° arc takes approximately 0.4 seconds. Faster rates can be achieved by using a faster processor.

The result of the acquisition scan determines the angle of incidence of the preferred RF signal. Once a preferred signal has been acquired, any change in the angle of incidence of the signal on the phased array receiver can be tracked. The initiation of a tracking routine can be controlled manually, or automatically executed at the end of the acquisition scan. The tracking routine allows for any movement of the transmitter, phased array receiver or intervening objects.

A person skilled in the art would recognize that there are several tracking routines that may be used. An example of a tracking routine is free running dither. In this routine the array loads a beam first to the left of the current position, and then to the right. The received signal power of the two dithered beams is measured and the results compared with that of the current center beam. The beam that gives the highest value then becomes the center beam for the next dither routine. It should be noted that unless the tracking steps are performed during a non-information carrying period of the signal some of the information contained in the signal will be lost.

A controlled dither technique can be used to minimize data loss during the tracking process. In the case of analogue FM video signals, beams are only loaded during the non-information carrying period of the signal. In other words, reconfiguration of the phased array is performed only when the microcontroller (60) receives a frame synchronization pulse from the decoder module (59). This ensures that the picture interval of the frame is undisturbed and minimizes visible picture interference.

The process of tracking a signal obviously requires more than one reconfiguration of the phased array antenna. The speed of reconfiguration of the phased array is determined by the speed of the microcontroller (60) and the associated electronics. Different types of signal will also have different non-information carrying periods of time.

For certain signal types and phased array systems it may be possible to perform sufficient reconfigurations of the phased array antenna during the non-information carrying period to perform a tracking routine which loads a beam first to the left of the current position, and then to the right of that position and selects which beam is to be used to receive during the next period; i.e. perform a left/right tracking procedure. This would be preferable if the variation of the angle of incidence of the signal on the phased array antenna was changing rapidly with time.

For a typical 66 MHz microcontroller, reconfiguration of the phased array takes approximately 0.8 ms. Following reconfiguration, it takes approximately 3.2 ms to obtain a measure of signal strength or quality. The signal strength or quality measurements can however be performed during the information carrying period of the signal without any detrimental effect on the receipt of information.

An FM video signal typically has a 1.5 ms non-information carrying period. A beam to the left of the current position may thus be loaded during one non-information carrying period and then a beam to the right of the current position loaded during the subsequent non-information carrying period. In this way movement in the angle of incidence of signals may be tracked.

If a signal had a longer non-information carrying period, or the speed of the microcontroller was increased, it would be possible to perform the left/right tracking procedure, with associated measurement of signal strength or quality, during the non-information carrying period.

According to the environment the number of beams that make up a tracking routine, as well as the angular separation between each beam, can be varied. The use of an increased number of beams during the tracking procedure will increase the time required for the tracking process, and may require a single tracking step to be performed over more than one non-information carrying period.

An acquisition scan can also be activated periodically, if the signal strength drops below a certain threshold or manually by an operator of the system.

When tracking an RF transmitter, the phased array receiver will generally use the line of sight path to support the RF link. If the line of sight link is lost, the phased array receiver can automatically start to scan the acquisition arc and locate any reflected signals being produced as a result of the operating environment. The strongest, or highest quality, reflected signal can then be acquired and tracked until the line of sight path becomes available again. In this way an RF link can be supported, even when the RF transmitter is not line of sight. As described previously, the use of a phased array antenna to support an RF link in the absence of a direct line of sight between the transmitter and receiver has numerous advantages over the conventional panner type system.

In addition, there may also be some situations when the line of sight path may not provide the best RF link performance; for example when both multi-path signals and the line of sight signal are incident on the phased array receiver within the receive beam. In this case the phased array antenna can select not to acquire the line of sight signal, but instead acquire and track a reflected signal that provides a higher quality video image.

It should be noted that the system can also be used if the transmitter and receiver are in fixed positions, but objects move into the direct line of sight or if objects from which the signal is being reflected change position.

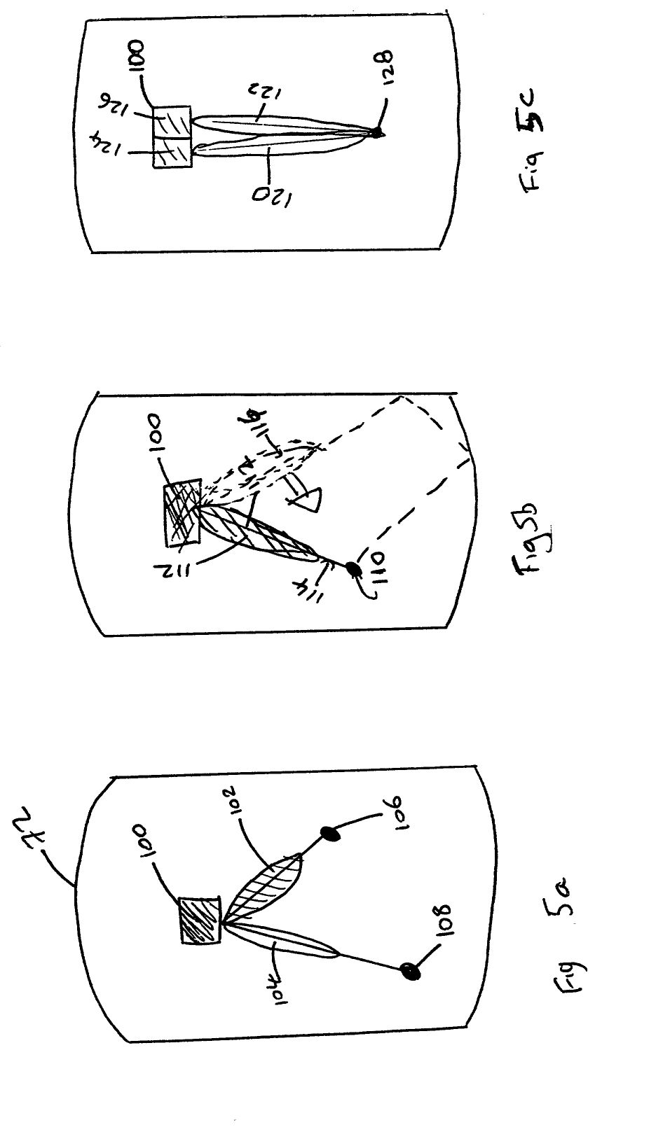

As described above with reference to FIG. 2, a plurality of independent receive beams may be formed using an LC phased array device. The use of multiple receive beams to acquire and track a transmitted signal will now be described with reference to FIGS. 5a-5c.

FIG. 5a shows a single phased array receiver (100), simultaneously forming a first receive beam (102) and a second receive beam (104). The first receive beam (102) and the second receive beam (104) can independently acquire and track a first transmitter (106) and a second transmitter (108). The first transmitter (106) and the second transmitter (108) must be transmitting at different frequencies.

In this configuration, the beams are independently steered and hence support links to transmitters operating at different frequencies within the system bandwidth. In this way a single antenna array, with a plurality of beam-forming hardware, could be used to track a plurality of transmitters.

Alternatively, two independent beams operating at the same frequency can be used to improve tracking. FIG. 5b shows a single phased array receiver (100), forming a first receive beam (112) that acquires and tracks one signal (114) transmitted by transmitter (110). A second receive beam (116) then sequentially forms beams across the acquisition arc searching for the optimum receive beam direction for the first receive beam (112) to adopt. Once an optimum receive direction has been established by the second receive beam, the first receive beam is directed accordingly. To minimize disruption to the RF link, the redirection of the first receive beam can be performed during any non-information carrying periods of the signal.

The example given in FIG. 5b refers to two independent beams, but this should not be seen as limiting. One or more beams can be dedicated to supporting RF links, whilst one or more additional beams can be continually scanning the acquisition arc searching for the beam position that will provide the best link performances for the next time slot. Again, to ensure disruption to the RF link is minimized, any redirection of the beams providing an RF link can be undertaken during non-information carrying periods of the signal.

In addition to the use of independent beams formed from a single phase center as described above, the phased array antenna can be configured so as to produce two or more beams from separate phase centers; this is called beam diversity and is well known to those skilled in the art of phased array radar. The beam diversity is obtained by using a subset of the array elements of the antenna to form beams. For example, if a 16 element LC array were used, two sets of 8 elements could be used so as to form beams from two diverse phase centers.

FIG. 5c shows how two independent beams (120 and 122) can be formed from two phase centers (124 and 126) on an LC phased array antenna. Each set of beams originating from a phase center can be controlled independently of the other beam sets. The beams can be controlled to track a single, or multiple, transmitters in the same way as beams originating from a single phase center as described with reference to FIGS. 5b and 5a. Again, disruption to the RF link is minimized by redirecting the beams supporting RF links during non-information carrying periods of the signal.

If, as shown in FIG. 5c, the two beams (120 and 122) both acquire and track a single transmitter (128) two separate links with the transmitter are provided. In this case, each link with the transmitter will be susceptible to different multipath interference effects because of the different position of each phase center. The beam providing the signal output of the highest quality can thus be selected to provide the RF link. The use of diverse beams can hence be used to provide greater resistance to multi-path effects.

The three examples described with reference to FIGS. 5a, 5b and 5c should not be seen as limiting. A person skilled in the art would immediately recognize how any of the techniques employed for tracking a single camera could be employed when tracking a plurality of cameras using a single antenna. Similarly, the techniques described with reference to FIGS. 5a and 5b could be performed for each of the diverse beams described with reference to FIG. 5c.

We claim:

1. A method of reading information from a signal transmitted by a transmitter, said method comprising the steps of:
providing a phased array antenna;
adjusting said phased array antenna to receive said signal; and
reading information from said received signal.

2. A method of reading information as claimed in claim 1, wherein said adjusting step includes the steps of:
using said phased array antenna to determine a direction of incidence of said signal on said phased array antenna; and
electronically steering said phased array antenna toward said signal.

3. A method of reading information as claimed in claim 1, wherein a plurality of signals transmitted by said transmitter are incident upon said antenna and said adjusting step includes the steps of:
using said phased array antenna to determine a direction of incidence of a strongest of said signals on said phased array antenna, and
electronically steering said phased array antenna to receive said strongest incident signal.

4. A method of reading information as claimed in claim 1, wherein a plurality of signals transmitted by said transmitter are incident upon said antenna, said adjusting step includes the steps of:
using said phased array antenna to determine a direction of incidence of a highest quality of said signals on said phased array antenna; and
electronically steering said phased array antenna to receive the incident signal of the highest quality.

5. A method of reading information as claimed in claim 1, wherein the adjusting step includes the steps of;
electronically steering said phased array antenna to receive said signal from said transmitter;
tracking any change in a direction of incidence of said signal; and
electronically steering said phased array antenna to receive said signal from any changed direction.

6. A method of reading information as claimed in claim 5, wherein said signal is comprised of an information carrying period and a non-information carrying period, and said steps of tracking and steering are performed substantially during said non-information carrying period of said signal.

7. A method of reading information as claimed in claim 1, wherein said step of providing a phased array antenna comprises the step of providing an LC phased array antenna.

8. A method of reading information as claimed in claim 1, wherein said signal transmitted by said transmitter comprises a frequency modulated video signal, and said adjusting step includes receiving said frequency modulated video signal.

9. A method of reading information as claimed in claim 8, wherein said frequency modulated video signal has a frequency in the range of 12.2 GHz to 12.5 GHz.

10. A method of reading information from at least two transmitters, each of said at least two transmitters transmitting a signal, said method comprising the steps of:
providing a phased array antenna;
electronically steering said phased array antenna to concurrently receive a signal transmitted by each said transmitter; and
reading information from said received at least two signals.

11. A method of reading information from at least two signals transmitted by a transmitter, said method comprising the steps of;
providing a phased array antenna;
electronically steering said phased array antenna to concurrently receive said at least two signals; and
reading information from said received at least two signals.

12. A receiver for receiving an incident signal, said incident signal including information herein, said receiver comprising:
a phased array antenna, said phased array antenna comprising an antenna array of a plurality of spatially separated antenna elements, each of said antenna elements producing an associated electrical signal in response to said incident signal,
a phase shifter applying a phase shift to each said associated electrical signal and producing a corresponding phase shifted electrical signal,
a phased array controller, said phased array controller controlling the phase shift applied by said phase shifters to said electrical signals, and
a combiner for combining said phase shifted electrical signals thereby producing an electrical output signal, wherein said applied phase shifts result in the information contained in said incident signal being output.

13. A receiver as claimed in claim 12, further including a signal strength monitor, said signal strength monitor measuring the strength of said electrical output signal.

14. A receiver as claimed in claim 12, further including a signal quality monitor, said signal quality monitor measuring the quality of said electrical output signal.

15. A receiver as claimed in claim 12 wherein said incident signal is comprised of a frequency modulated analogue video signal.

16. A receiver for receiving at least two incident signals, said incident signals including information therein, said receiver comprising:
a phased array antenna, said phased array antenna comprising an antenna array of a plurality of spatially separated antenna elements, each of said antenna elements producing associated electrical signals in response to said incident signals,
at least two phase shifters, each phase shifter applying a phase shift to each said associated electrical signals and producing corresponding phase shifted electrical signals,
a phased array controller, said phased array controller controlling the phase shift applied by said phase shifters to said electrical signals applied by said additional phase shifter; and
a combiner for combining said phase shifted electrical signals thereby producing at least two electrical output signals, wherein said applied phase shifts result in the information contained in said at least two incident signals being output.

17. A receiver as claimed in claim 16, further including at least one signal strength monitor, said signal strength monitor measuring the strength of at least one of said at least two electrical output signals.

18. A receiver as claimed in claim 16, further including at least one signal quality monitor, said signal quality monitor measuring the quality of at least one of said two electrical output signals.
